(19) United States
(12) Patent Application Publication
(10) Pub. No.: US 2016/0305549 A1
(43) Pub. Date: Oct. 20, 2016

(54) TOOTHED METALLIC GASKET INTERPENETRATED WITH COMPRESSION-RESISTANT STEPS

(71) Applicant: ENVIRONMENTAL GASKET COMPANY, LTD., Nanjing, Jiangsu (CN)

(72) Inventors: Jingwei ZHAO, Nanjing, Jiangsu (CN); Jun ZHANG, Nanjing, Jiangsu (CN); Fan YANG, Nanjing, Jiangsu (CN)

(21) Appl. No.: 15/101,502

(22) PCT Filed: Jan. 7, 2014
(86) PCT No.: PCT/CN2014/070249

§ 371 Date: Jun. 3, 2016

(30) Foreign Application Priority Data
Dec. 6, 2013 (CN) 201310655211.4

(51) Int. Cl. F16J 15/12

(52) U.S. Cl. CPC F16J 15/122

(57) ABSTRACT

The present invention discloses a toothed metallic gasket interpenetrated with compression-resistant steps. Metallic seal teeth, arranged concentrically and inclined towards a pressure source, are processed on upper and lower sides of a metallic framework. Compression-resistant steps are provided on two sides of or between the metallic seal teeth. The height of the compression-resistant steps is 30%-80% of that of the adjacent teeth. The compression-resistant steps and the seal teeth are covered and filled with nonmetallic sealing material.

### TECHNICAL FIELD

The present invention relates to a seal gasket, particularly to a toothed metallic gasket interpenetrated with compression-resistant steps.

### BACKGROUND OF THE INVENTION

A conventional toothed gasket (for example, as disclosed in Patent Application No. DE2437567 entitled “Seal Gasket”) is a gasket with triangular sharp toothed rings concentrically arranged on a metallic framework. The triangular sharp teeth and the metallic framework are integrated as a whole. Generally, several circles of concentric toothed rings, with an included angle of 90, are processed on two surfaces of a metallic flat gasket via precise lathes. The toothed rings are in sharp-corner contact with a flange face. The toothed gasket may be directly used as a metallic gasket, or processed into a composite gasket that has internal and external locating rings and is additionally laminated with flexible graphite or a polytetrafluoroethylene sealing element on two surfaces. Such toothed metallic gaskets have the following long-standing problems: the sharp corners will damage the flange sealing surface, and themselves are likely to be crushed and damaged; and, when the loading force applied to the gasket fluctuates or the precision of the flange declines, seal leakage is likely to result in; this is particularly valid in the case of an excessive loading force being applied to the gasket, as there is no overload protection in this gasket design, seal failure often results from the crushing of or damage to the toothed rings due to over compression, and such failure is disastrous to the environment, safe production and personal safety. The above design fails to take into account the previously mentioned likely possibility of gasket over compression, crushing of and damage to the toothed gasket sealing elements and, most importantly, how to prevent such a result. The external or internal locating rings are mainly for the purpose of radial and concentric locating with no special anti-crushing function and are in fixed locations, so not all teeth can be protected. However, for teeth that are arranged continuously, specific compression-resistant mechanisms interpenetrated between the continuous teeth are apparently required to ensure that each tooth will not be over-compressed, damaged or crushed. There should be an apparent distinction between the height of such compression-resistant mechanisms and the height of common teeth and locating rings. If the compression-resistant mechanisms are too high, the resilience will be influenced; and if the compression-resistant mechanisms are too low, they have no anti-crushing function.

### SUMMARY OF THE INVENTION

To solve the deficiencies of the prior art and to have an essential difference from the above technology, an object of the present invention is to provide a toothed metallic gasket interpenetrated with compression-resistant steps, which has the advantages of safety in use and long-lasting and stable sealing performance even if the loading force applied to the gasket fluctuates and even in the case of overload.

The present invention employs the following technical solutions.

A toothed metallic gasket interpenetrated with compression-resistant steps is provided, comprising a metallic framework and metallic seal teeth arranged concentrically on upper and lower sides of the metallic framework. The metallic seal teeth and the metallic framework are integrated as a whole. Compression-resistant steps are provided on two sides of or between the concentrically arranged metallic seal teeth. The height of the compression-resistant steps is 30%-80% of that of the adjacent teeth, and is apparently higher than that of the metallic framework. Nonmetallic sealing material is filled between the compression-resistant steps and the adjacent teeth. The compression-resistant steps are not inclined, the tops of which are designed to be non-sharp contact corners.

Inclining towards a pressure source, the metallic seal teeth are inclined linear teeth, arc teeth, falcate teeth or combinations thereof, the tops of which are designed to be flat contact corners, arc contact corners or waved contact corners.

When a locating ring is provided on the outside of the gasket, the compression-resistant steps are provided on the locating ring, and the height of the compression-resistant steps is higher than that of the locating ring.

The compression-resistant steps are adjacent to one or more of the seal teeth, and one compression-resistant step is to be interpenetrated between every three seal teeth at most. The seal teeth beside the compression-resistant steps may be inclined or bent towards a pressure source, or arranged vertically.

The nonmetallic sealing material is covered on the seal teeth as a whole to form a nonmetallic sealing layer; or, the nonmetallic sealing material is not only filled between the compression-resistant steps and the adjacent teeth, but also covered on the seal teeth as a whole.

The present invention has the following advantages:

(1) the compression-resistant steps provided between the continuous teeth have a mechanism playing a special compression-resistant function, so that the gasket is protected from being crushed or damaged and the disastrous consequence due to seal failure is reduced greatly; (2) in a specially designed height, the compression-resistant steps can ensure that the seal teeth are maintained within an optimal elastic range without crushing, so that the life span of the seal and the ability to adapt to changes of the working environments of the gasket are improved obviously; (3) a design in which one compression-resistant step should be interpenetrated between every three seal teeth at most ensures that all seal teeth are stressed evenly and thus protected in the case of uneven flange sealing surface and non-uniform pressure; (4) the tops of the compression-resistant steps are designed to be flat contact corners, arc contact corners or waved contact corners, so that the flange will not be damaged; and, (5) if the pre-tightening force is too large and when the seal teeth have been flattened and are likely to lose efficacy, the several circles of compression-resistant steps distributed between the seal teeth may be in contact with the flange sealing surface; furthermore, in the case that the nonmetallic material between the seal teeth and the flange is squeezed out, spare seal lines for providing additional sealing performance may be formed on the tops of the compression-resistant steps in flat contact corners, arc contact corners or waved contact corners, so that a secondary compression-resistant and seal protection mechanism is obtained.

### BRIEF DESCRIPTIONS OF THE DRAWINGS

FIG. 1 is a schematic diagram of a toothed metallic gasket with falcate seal teeth, interpenetrated with compression-resistant steps;

FIG. 2 is a schematic diagram of a toothed metallic gasket with arc seal teeth, interpenetrated with compression-resistant steps;

FIG. 3 is a schematic diagram of a toothed metallic gasket with bidirectional falcate seal teeth, interpenetrated with compression-resistant steps;

FIG. 4 is a schematic diagram of a toothed metallic gasket with falcate seal teeth in a 1+1+2+1+3 combination way, interpenetrated with compression-resistant steps;

FIG. 5 is a schematic diagram of a toothed metallic gasket with falcate seal teeth in a 1+2+1+2 combination way, interpenetrated with compression-resistant steps;

FIG. 6 is a schematic diagram of a toothed metallic gasket with falcate seal teeth in a 1+3 combination way, interpenetrated with compression-resistant steps;

FIG. 7 is a schematic diagram of a toothed metallic gasket with arc seal teeth in a staggered way, interpenetrated with compression-resistant steps;

FIG. 8 is a schematic diagram of a toothed metallic gasket with falcate and arc seal teeth, interpenetrated with compression-resistant steps;

FIG. 9 is a schematic diagram of a toothed metallic gasket with inclined seal teeth, interpenetrated with compression-resistant steps; and

FIG. 10 is a schematic diagram of a toothed metallic gasket with seal teeth from straight to inclined, interpenetrated with compression-resistant steps.

### DETAILED DESCRIPTION OF THE INVENTION

A toothed metallic gasket interpenetrated with compression-resistant steps is provided. Various seal teeth 1 and compression-resistant steps 2 interpenetrated between the seal teeth 1 are distributed, in a ring form, on upper and lower end faces of a metallic framework of the gasket. The contact surface of the compression-resistant steps 2 and a flange is planar, and the center line of the contact surface is vertical to the ring surface. The height of the compression-resistant steps 2 is lower than that of the adjacent seal teeth 1, but higher than that of the metallic framework of the gasket or that of an external locating ring 3. One compression-resistant step 2 is to be provided between every three seal teeth 1 at most. The arrangement and structure of the compression-resistant steps 2 and the seal teeth 1 may be configured flexibly depending on practical applications.

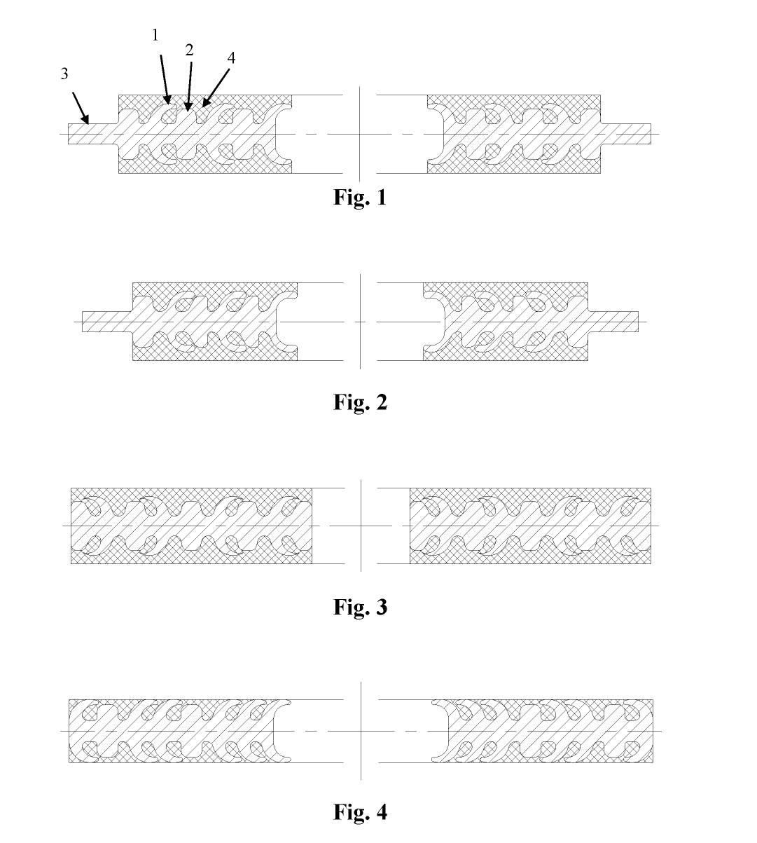

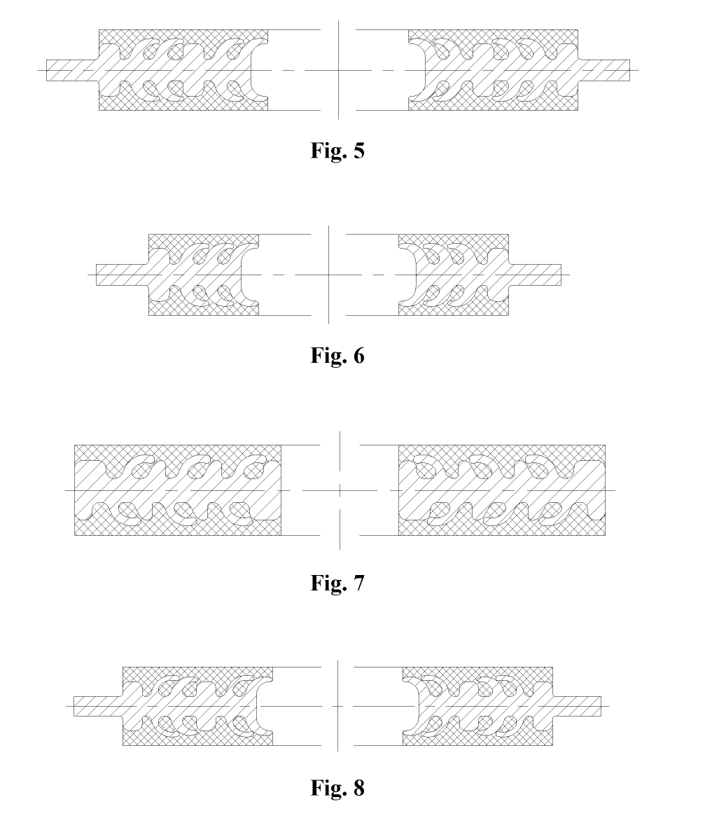

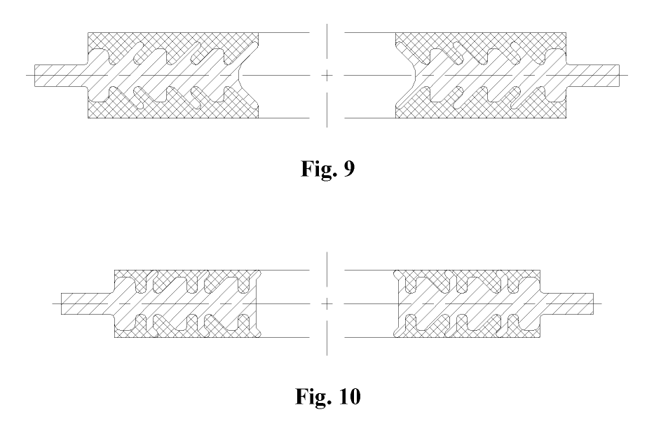

As shown in FIG. 1, in the toothed metallic gasket interpenetrated with compression-resistant steps, each of the seal teeth 1, designed to be falcate, is provided with a compression-resistant step 2 in the middle, and nonmetallic material 4, such as graphite, is filled between the compression-resistant steps 2 and the seal teeth. In FIG. 2, the seal teeth are designed to be arc, and the compression-resistant steps are designed to be trapezoidal. In FIG. 3, the seal teeth of this gasket are in an inverse design. In FIG. 4, the seal teeth and compression-resistant steps are combined in a way of 1+1+2+1+3, and are shown that the contact surface between the seal teeth and the flange is a chambered surface when the nonmetallic sealing material is squeezed out. In FIG. 5, the seal teeth and compression-resistant steps are combined in a way of 1+2+1+2, and are shown that clearances between the teeth are filled with the nonmetallic sealing material. In FIG. 6, the seal teeth and compression-resistant steps are combined in a way of 1+3. In FIG. 7, the seal teeth and the compression-resistant steps are staggered up and down. In FIG. 8, different seal teeth and the compression-resistant steps are combined. In FIG. 9, the seal teeth of this gasket are designed to be inclined. In FIG. 10, the seal teeth of this gasket are designed to be inclined from straight.

Compared with the prior art, the present invention has two advantages essentially: first, the compression-resistant steps provided for this gasket may ensure that the seal teeth obtain uniform enough seal compression and resilience, thereby solving the long-standing problem in toothed metallic gaskets that the metallic seal teeth are likely to be crushed and damaged due to an excessive loading force resulting in seal failure; and second, in the case that the nonmetallic material between the seal teeth and the flange is squeezed out, the compression-resistant steps of this gasket can still retain a nonmetallic seal which provides an additional secondary compression-resistant and seal protection mechanism for the gasket. As a supplementary design feature, in the case that the seal teeth are inclined teeth, the compression-resistant steps further can retain tension to maintain an elastic seal. Compared with the previous designs, with the advantages and combinations thereof as described above, the sealing reliability and safety in use of the gasket are guaranteed and improved greatly.

1. A toothed metallic gasket interpenetrated with compression-resistant steps, comprising a metallic framework and metallic seal teeth arranged concentrically on upper and lower sides of the metallic framework, the metallic seal teeth and the metallic framework being integrated as a whole, characterized in that compression-resistant steps are provided on two sides of or between the concentrically arranged metallic seal teeth; the height of the compression-resistant steps is 30%-80% of that of the adjacent teeth and apparently higher than that of the metallic framework; nonmetallic sealing material is filled between the compression-resistant steps and the adjacent teeth; and the compression-resistant steps are not inclined, the tops of which are designed to be non-sharp contact corners.

2. The toothed metallic gasket interpenetrated with compression-resistant steps according to claim 1, characterized in that, inclining towards a pressure source, the metallic seal teeth are inclined linear teeth, arc teeth, falcate teeth or combinations thereof, the tops of which are designed to be flat contact corners, arc contact corners or waved contact corners.

3. The toothed metallic gasket interpenetrated with compression-resistant steps according to claim 1, characterized in that, when a locating ring is provided on the outside of the gasket, the compression-resistant steps are provided on the locating ring, and the height of the compression-resistant steps is higher than that of the locating ring.

4. The toothed metallic gasket interpenetrated with compression-resistant steps according to claim 1, characterized in that the compression-resistant steps are adjacent to one or more of the seal teeth, and one compression-resistant step is to be interpenetrated between every three seal teeth at most.

5. The toothed metallic gasket interpenetrated with compression-resistant steps according to claim 1, characterized in that the nonmetallic sealing material is covered on the seal teeth as a whole to form a nonmetallic sealing layer; or, the nonmetallic sealing material is not only filled between the compression-resistant steps and the adjacent teeth, but also covered on the seal teeth as a whole.

6. The toothed metallic gasket interpenetrated with compression-resistant steps according to claim 2, characterized in that, when a locating ring is provided on the outside of the gasket, the compression-resistant steps are provided on the locating ring, and the height of the compression-resistant steps is higher than that of the locating ring.

7. The toothed metallic gasket interpenetrated with compression-resistant steps according to claim 2, characterized in that the compression-resistant steps are adjacent to one or more of the seal teeth, and one compression-resistant step is to be interpenetrated between every three seal teeth at most.

8. The toothed metallic gasket interpenetrated with compression-resistant steps according to claim 2, characterized in that the nonmetallic sealing material is covered on the seal teeth as a whole to form a nonmetallic sealing layer; or, the nonmetallic sealing material is not only filled between the compression-resistant steps and the adjacent teeth, but also covered on the seal teeth as a whole.
